(19) United States
(12) Patent Application Publication
(10) Pub. No.: US 2004/0114101 A1
(43) Pub. Date: Jun. 17, 2004

(54) Contact lenses with color shifting properties

(75) Inventor: Ashok R. Thakrar, San Jose, CA (US)

Correspondence Address: STOUT, UXA, BUYAN & MULLINS LLP, 4 VENTURE, SUITE 300, IRVINE, CA, 92618, US

(73) Assignee: Ocular Sciences, Inc., Concord, CA

(21) Appl. No.: 10/730,522

(22) Filed: Dec. 8, 2003

Related U.S. Application Data
(60) Provisional application No. 60/433,108, filed on Dec. 13, 2002.
(60) Provisional application No. 60/440,257, filed on Jan. 15, 2003.

(51) Int. Cl. G02C 7/04

(52) U.S. Cl. 351/162

(57) ABSTRACT

A contact lens is provided including a lens body and an image component effective in producing a color shifting appearance of the contact lens. For example, the image component may include a light diffracting component made up of flakes of a multilayered interference film suspended in a polymeric medium.

### CROSS-REFERENCE TO RELATED APPLICATIONS

This application claims the benefit of U.S. Provisional Application No. 60/433,108, filed Dec. 13, 2002, and U.S. Provisional Application No. 60/440,257, filed Jan. 15, 2003, the disclosures of both of which are hereby incorporated by reference in their entireties.

### BACKGROUND OF THE INVENTION

The present invention generally relates to contact lenses and more specifically relates to contact lenses having color shifting properties.

Commercially available colored/tinted contact lenses have been steadily gaining popularity since their introduction into the marketplace. For example, there are many commercially available lenses available for those who wish to temporarily alter their eye color.

Such colored/tinted contact lenses typically incorporate opaque dyes of various colors into the lens during the lens manufacturing process. A variety of such contact lenses and methods for making them have been described and proposed.

Examples of various tinted or colored contact lens may be found in Knapp, U.S. Pat. No. 4,582,402, Rawlings et al., U.S. Pat. No. 5,120,121, Evans, et al., U.S. Pat. No. 5,302,978, Jahnke, U.S. Pat. No. 5,414,477 and Doshi, U.S. Pat. No. 6,315,410. The disclosure of each of these patents is incorporated in its entirety herein by this reference.

Commercially available colored contact lenses utilize inorganic pigments such as titanium dioxide, iron oxides, chromium oxides, or organic pigments and dyes.

Such pigments and dyes used in conventional tinted or colored contact lenses typically change the appearance of the eye by simply adding color to the lens. Not surprisingly, developers of colored contact lenses often strive to achieve the most natural-looking appearance to the eye (while simply altering the color, for example from brown to green). In order to project a natural looking appearance, the colors are oftentimes printed on the lens in the pattern of an iris.

There is also a demand, however, for contact lenses that will provide more dramatic changes to the appearance of the eye, for example, by adding brilliant colors or designs that are not naturally found in a human eye.

There is an increasing demand for new safe and effective contact lenses and methods of manufacturing same, that will subtly or dramatically change the appearance of an eye.

### SUMMARY OF THE INVENTION

An ophthalmic lens in accordance with the present invention generally comprises a lens body having an optical region, an anterior surface and a posterior surface, and an image component disposed on or within said lens body, said component being effective in producing a spectral appearance, or color shifting appearance, to the eye wearing the lens.

The term “color shifting” as used herein, generally refers to a characteristic of an object that causes the object to exhibit the property of changing color upon variation of an angle of incident light, or as the viewing angle of the observer is shifted. Thus, lenses, such as contact lenses, in accordance with the present invention, appear (to an observer of the lens) to change color intensity and/or hue with each movement of incident light upon the eye wearing the lens or with a change of the observer's viewing position. In some embodiments of the invention, the lenses generate the appearance of multiple bright rainbow prisms moving over a liquid silver color. These lenses have an elegant and dramatic visual appeal that is quite unique.

In a broad aspect of the invention, the image component comprises a light-diffracting component. For example, the image component may comprise a multilayered interference film that produces a color shifting effect when light is directed toward the light diffracting component.

In another broad aspect of the invention, a contact lens is provided comprising a lens body and an image component provided on or in said lens body to create a colored image and structured to interfere with incident light to cause a color of the image to change when the lens is viewed from different angles.

In a specific embodiment of the invention, the image component comprises a light diffractive colorant comprising a light interference pigment or color shifting pigment suspended within a medium and applied to at least a portion of the lens body.

The image component may comprise one or more traditional opaque pigments combined with one or more light diffractive colorants. Alternatively, the image component may comprise alternate layers of opaque pigments and light diffractive colorants.

In one particular embodiment of the invention, the image component is substantially absent of any intrinsic color. For example, the image component may comprise a light diffractive colorant comprising flakes of a multilayered interference film that is substantially optically transparent or even clear. Although optically transparent, the image component is effective in diffracting light and producing various interference wavelengths in the visible spectrum, thereby producing an apparent color to a viewer of the lens that appears to shift and flow as the viewing angle or an angle of incident light changes.

In a particularly advantageous feature of the invention, the lens is structured so that when light, for example white light, is directed toward the lens, one or more wavelengths of light are diffracted by the image component, and the eye of the wearer appears to shift or change in hue depending upon the viewing angle of an observer.

For example, the image component may comprise layers of different materials, for example layers of light diffracting materials, that have different indices of refraction, or various absorptive, reflective and/or diffractive properties to achieve a desired color shifting appearance of the lens.

In an especially advantageous embodiment of the invention, the image component comprises at least one multilayered interference film, for example in particulate form, the film being effective in exhibiting a desired light interference property. Preferably, the image component comprises one or more different multilayered interference films in flake form. In some embodiments of the invention, the image component comprises a variety of different multilayered interference films, for example in flake form, wherein each of the different films is effective in exhibiting a different light interference property.

In a more specific embodiment of the invention, the image component comprises flakes of a multilayered interference film randomly distributed throughout, or suspended within, a binder material. The binder material may comprise a co-polymer, for example a poly(HEMA)/GMA binder material, which is a co-polymer of HEMA (2-hydoxyethyl methacrylate) and Glycidyl Methacrylate or glyceryl monomethacrylate.

Flakes of multilayered interference films are commercially and otherwise available for example in the form of light interference pigments marketed under the trademarks ChromaFlair® and SpectraFlair®, and manufactured and sold by Flex Products, Inc. (Santa Rosa, Calif.).

In another aspect of the invention, the image component comprises particles of a multilayered interference film and particles of a reflective or pigmented material suspended within a polymeric material and printed on a surface of the lens body.

In one embodiment of the invention, the image component is disposed on or within an annular zone surrounding the optical region of the lens body and the optical region is substantially free of the component. For example, the image component may be located on or in the lens to define an annular surface consistent in size and shape with an iris of the eye to be wearing the lens such that the pupil area of the lens is substantially free of the image component.

The image component may be coated around the lens body, or, may be disposed on only a portion of the lens body, for example, on the anterior surface of the lens body. For example, the image component may be provided as a printed image on the anterior surface of the lens body. In one embodiment of the invention, the image component is printed on the lens body by means of, for example, an ink jet printer or other suitable means.

Alternatively, the image component may be disposed between an anterior surface and a posterior surface of the lens body to define an annulus of a light diffracting material having an opening around an optic zone of the lens.

In another aspect of the invention, a contact lens is provided which generally comprises a lens body, and an image component provided on or in the lens body to create an image of an iris, the image component being structured to interfere with at least one wavelength of light to cause a color or appearance of the iris image to change, for example when the lens is viewed from different angles.

In yet another aspect of the invention, an image component comprises one or more layers of pigment particles, disposed on or in the lens body and structured and positioned to create a three-dimensional appearance of at least a portion of an eye. The pigment particles may comprise opaque, translucent or transparent particles.

In a further aspect of the invention, an image component may be provided on a lens that causes the lens to glow. Any suitable material, such as a polymeric material, that permits energy to be absorbed and to be emitted as light may be used to provide a glowing property to the lens.

In at least one embodiment, polymer particles such as cholesteric liquid crystal (PCLC) and phosphorescent pigments may be used to provide a glowing effect or glowing property to the lens. Examples of phosphorescent pigments include pigments that have the capability of absorbing light energy at one wavelength and releasing it in packets at a lower wavelength. The energy release is typically delayed and the re-emission process varies by pigment type and can last for several hours depending on length and size of the excitation process. Some examples of phosphorescent pigments that may be provided with the lenses disclosed herein include inorganic oxides, such as doped zinc sulphide (ZnS) complexes. The ZnS complexes may include a crystal lattice that contains implanted metal-ions such as Sr⁺, Ca²⁺, Li⁺, Cd²⁺ or other metals in relatively low concentrations. Phosphorescent pigments may also be organic, as opposed to inorganic. Products containing organic pigments are known for their special effects such as “glow-in-the-dark” effects. In certain industries, such as toy industries, safety industries, highway industries, and road marking industries, typical “glow-in-the-dark” colors are red, green and/or yellow. Similar or other colors may be used in the lenses disclosed herein.

In certain embodiment, the at least one pigment layer may comprise a plurality of ink pixels, for example, dispensed from a printer, for example an ink-jet printer. The ink may comprise particles of color-shifting materials. The particles may be relatively small, and have a dimension or size less than one hundred micrometers. To achieve certain visual effects, at least a minor portion of the ink pixels may be at least partially or completely bleached. The ink pixels may be printed on the lens in the form of a digital image, for example, in a pattern of an iris of an eye. Furthermore, in accordance with the invention, the image component may comprise several different layers of pigment particles, for example, wherein each layer has a different color and/or pattern of pigment, in order to achieve a desired visual effect.

The present invention also provides a method for making an ophthalmic lens, for example a contact lens having light or color shifting properties. Generally, a method for making a lens in accordance with the invention may comprise the steps of printing a digital image on a substrate and transferring the image printed on the substrate to a surface of an optically clear lens. In certain embodiments, the colored inks disclosed herein are printed on a dark background, for example, a black background, that is disposed on a surface of the lens body. For example, a dark ink, or other similar material, may be applied to the anterior surface of the lens body, and the color-shifting inks disclosed herein may then be applied over the dark background.

In one embodiment, the printing step comprises printing an iris pattern on a substrate, for example a substantially flat, releasable substrate, using a laser printer or an ink-jet printer.

The printing step may more specifically comprise dispensing at least one colored ink, or a plurality of different colored inks onto the substrate.

In one embodiment of the invention, the method further comprises the step of obtaining a digital image of an iris of an eye, and using that digital image for the printing step, for example a printing a light diffracting material alone or in combination with one or more different colored inks, onto the substrate to form the pattern of an iris.

The transferring step may comprise transferring the printed image onto a resilient pad and transferring the image from the resilient pad onto the surface of the lens.

For example, the image may be transferred from the resilient pad by pressing the resilient pad with the image located thereon and the surface of the lens together so that the image is transferred from the pad to the lens.

The transferring step may further comprise positioning the substrate with the image located thereon adjacent to the surface of the lens so that the image can be directly transferred from the substrate to the lens body.

Any and all features described herein and combinations of such features are included within the scope of the present invention provided that the features of any such combination are not mutually inconsistent. In addition, any feature or combination of features may be specifically excluded from any embodiment of the present invention.

These and other features, aspects and advantages of the present invention will become apparent hereinafter, particularly when considered in conjunction with the following claims and detailed description in which like parts bear like reference numerals.

### BRIEF DESCRIPTION OF THE DRAWINGS

FIG. 1 is a front view of a contact lens including a lens body and an image component, in accordance with the present invention.

FIG. 2 is a vertical sectional view of the contact lens of FIG. 1 taken at lines 2-2.

FIG. 3 is a vertical sectional view of another contact lens in accordance with the invention, wherein the image component is in the form of an annular ring within the lens body.

FIG. 4 is an enlarged view of a peripheral portion of the image component of the invention taken along line 4 of FIG. 3.

FIGS. 5 and 6 are schematic depictions of color shifting multilayered interference films suitable for use in the present invention.

### DETAILED DESCRIPTION

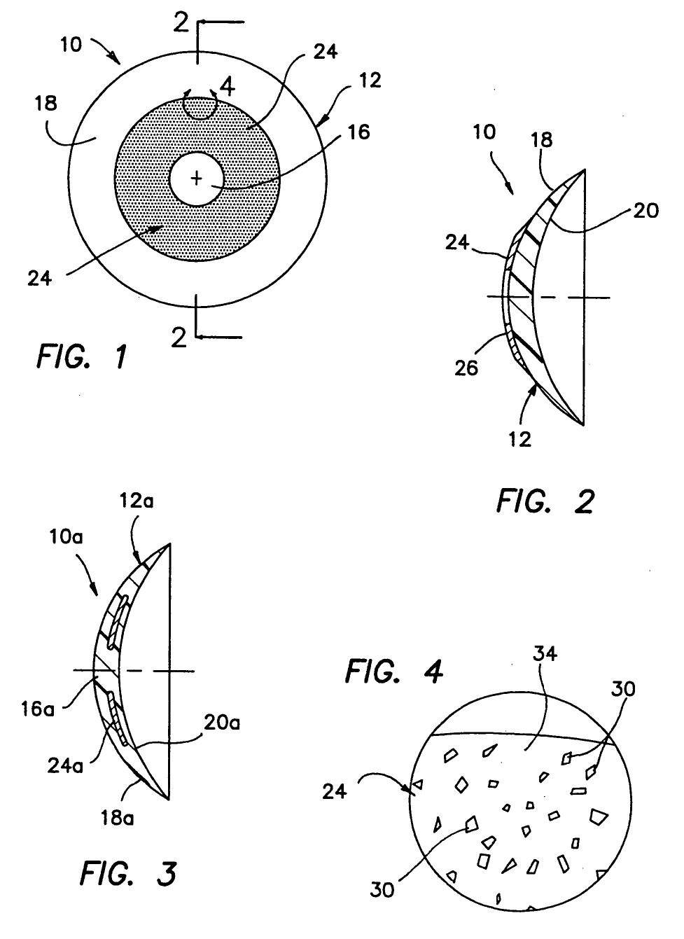

Turning now to FIGS. 1 and 2, an ophthalmic lens 10, in accordance with the present invention is shown. Although the ophthalmic lens 10 is shown and hereinafter described as being in the form of a contact lens, it is to be appreciated that the present invention may include other types of ophthalmic lenses, such as for example, but not limited to, corneal onlays.

The lens 10 generally comprises a lens body 12 having an optical region 16, an anterior surface 18 and a posterior surface 20 (posterior surface 20 not shown in FIG. 1). The lens 10 further comprises an image component 24 disposed on or within said lens body 12, said component 24 being effective in producing a light-shifting appearance, more specifically a color shifting appearance, of the contact lens 10 when worn on an eye.

The contact lenses 10 in accordance with the invention may be flexible, soft silicone or hydrophilic silicone lenses or soft lenses made from other hydrophilic materials, such as suitable hydrogel-forming polymeric materials and the like. The present contact lenses may also be “hard” or “rigid” lenses including gas permeable lenses. Materials which are suitable for use in the present lenses include, without limitation, conventional hydrogel materials, for example, hydroxyethyl methacrylate (HEMA)-based materials, silicone-hydrogel materials, gas permeable materials, lens materials described in Nicolson et al U.S. Pat. No. 5,849,811, other ophthalmically compatible lens materials, for example, many of which are well known to those skilled in the art, and the like and combinations thereof.

Still referring to FIGS. 1 and 2, the image component 24 is preferably disposed on or within an annular zone 26 surrounding the optical region 16 of the lens body 12 and the ocular region 16 is substantially free of the image component 24.

In FIG. 2, the image component 24 is shown layered on the anterior surface 18 of the lens body 12. For example, the image component 24 is provided as a printed image. The thickness of the image component 24 is determined or selected to reduce and preferably minimize any discomfort to the wearer of the lens. Accordingly, the image component 24 may be sufficiently thin so that a wearer of the lens does not notice or feel a junction at a perimeter of the image component.

An alternative embodiment 10a of the invention is shown in FIG. 3, with like parts bearing like reference numbers. The image component 24a is incorporated into at least a portion of the lens body 12a. More particularly, the image component 24a is disposed between the anterior surface 18a and the posterior surface 20a of the lens body 12a to define an annulus having an opening around the optic zone 16a.

In a broad aspect of the invention, the image component 24 comprises a light diffracting component. For example, the image component may comprise a light-diffracting material such as a multilayered interference film that produces a color shifting effect when applied to the lens body. The multilayered interference film may, for example, comprise multiple layers of materials having different indices of refraction such that, through the physics of light interference, the lens appears to change colors when an angle of incidence of light changes.

In another aspect of the invention, the image component comprises a light diffractive colorant comprising particles, preferably flakes, of a multilayered interference film said particles being distributed throughout a medium, for example a polymeric medium. The polymeric medium may comprise, for example, a polyHEMA/GMA polymeric material. Other suitable media include polymeric components with one or more groups selected from amide, amine, sulfate, ether, ester, hydroxyl, epoxy, acrylic functional groups, other effective functional groups, and the like, and mixtures thereof. Additional polymeric materials suitable for use in the lenses disclosed herein include those materials disclosed in U.S. application Ser. No. 10/306,716, filed Nov. 27, 2002, the entire contents of which are hereby incorporated by reference.

When particles are employed in the manufacture of the image component it may be desirable to use particles having a small size. For example, the particles may have a dimension, such as a length, width, height, thickness, diameter, or area, of about 100 micrometers or less. In certain embodiments, the particles have a size less than about 25 micrometers. Employing particles of small size may be beneficial when the image component is applied to a lens using the methods disclosed herein.

In one embodiment, the light diffractive colorant of the image component may comprise a commercially available light interference pigment or color shifting pigment that is mixed with a medium for example a liquid medium. The colorant is applied to, or is incorporated within at least a portion of the lens body to create a color shifting lens in accordance with the invention. Suitable light interference pigments are commercially and otherwise available, for example those marketed under the trademarks ChromaFlair® and SpectraFlair®, and manufactured by Flex Products, Inc. ChromaFlair particles typically have a size or dimension of between about 11 and about 13 micrometers. SpectraFlair particles typically have a size or dimension of between about 20 and about 22 micrometers.

In embodiments where the liquid medium is a water-containing liquid, it may be desirable to make certain components, such as metallic components, of the light diffractive colorant less reactive to reduce the potential for generating undesirable by-products with the liquid or components within the liquid. More specifically, ChromaFlair® and SpectraFlair® include aluminum, which may be exposed to water contained in the liquid. When exposed to aqueous solutions, the aluminum may react with water to generate hydrogen gas. Thus, it may be desirable to expose the aluminum to a passivator that acts as a surface passivation agent that forms a bond with the metallic surface before the colorant is applied to the lens body. By forming a bond with the metallic component, such as aluminum, oxidation is reduced, and preferably substantially prevented, thus rendering the metallic component less reactive towards the water-containing medium. Any suitable passivator may be used, and examples include and are not limited to organic acid phosphates, such as Additol® XL 250 (Solutia, Inc., St. Louis, Mo.) and Vircopet® 40 (Albright and Wilson Americas, Inc., Glen Allen, Va.). The passivator is generally mixed with the colorant, and may be mixed with one or more additional components such as water, alcohols, and other agents that improve the mixing and passivation of the metals contained in the colorant. After being mixed, the resulting dispersion is applied with the materials for forming or coating the lens.

Other light interference pigments and colorants useful in the present invention are contemplated. Generally, the color shifting properties of the colorant can be controlled through proper design of the optical coatings or films used to form the flakes. Desired effects can be achieved through the variation of parameters such as thickness of the layers forming the flakes and the index of refraction of each layer. The changes in perceived color which occur for different viewing angles or angles of incident light are a result of a combination of selective absorption of the materials comprising the layers and wavelength dependent interference effects. The absorption characteristics of a material are responsible for the basic color which is observed. The interference effects, which arise from the superposition of the light waves that have undergone multiple reflections and transmissions within the multilayered thin film structure, are responsible for the shifts in perceived color with different angles.

In some embodiments of the invention, the image component 24 comprises a light diffracting material that is substantially absent of any intrinsic color. For example, the image component may comprise a material, such as an optically clear, transparent or translucent multilayered interference film having no absorption color, but that displays, for example a rainbow spectral color, through the physics of light interference. Thin film flakes having a preselected single color have been previously produced, such as disclosed in U.S. Pat. No. 4,434,010 to Ash, in which flakes composed of symmetrical layers may be used in applications such as automotive paints and the like. The flakes are formed by depositing a semi-opaque metal layer upon a flexible web, followed by a dielectric layer, a metal reflecting layer, another dielectric layer, and finally another semi-opaque metal layer. The thin film layers are specifically ordered in a symmetric fashion such that the same intended color is achieved regardless of whether the flakes have one or the other lateral face directed towards the incident radiation.

Examples of useful color shifting thin films are disclosed in U.S. Pat. No. 4,705,356 to Berning et al. In one embodiment therein, a three layer metal (1)-dielectric-metal (2) stack is disclosed in which metal (1) is a relatively thin, highly absorptive material, metal (2) is a highly reflecting, essentially opaque metal, and the dielectric is a low index of refraction material.

Other thin film flakes which may be useful in the present invention are disclosed in U.S. Pat. No. 5,135,812 to Phillips et al. According to this patent, a symmetrical optical multilayer film is composed either of transparent all-dielectric stacks, or transparent dielectric and semi-transparent metallic layered stacks. In the case of an all-dielectric stack, the optical coating is made of alternating layers of high and low index of refraction materials. Suitable materials disclosed are zinc sulfide or titanium dioxide for the high index layers, and magnesium fluoride or silicon dioxide for the low index layers. High chroma interference platelets for use in paints, including color shifting and nonshifting single color platelets, are disclosed in U.S. Pat. No. 5,571,624 to Phillips et al and may be useful in the present invention. These platelets are formed from a symmetrical multilayer thin film structure in which a first semi-opaque layer such as chromium is formed on a substrate, with a first dielectric layer formed on the first semi-opaque layer. An opaque reflecting metal layer such as aluminum is formed on the first dielectric layer, followed by a second dielectric layer of the same material and thickness as the first dielectric layer. A second semi-opaque layer of the same material and thickness as the first semi-opaque layer is formed on the second dielectric layer. For the color shifting designs, the dielectric materials utilized have an index of refraction less than 2.0, such as magnesium fluoride. For the nonshifting designs, the dielectric materials are selected to have an index of refraction greater than 2.0, such as titanium dioxide or zinc sulfide.

Any pigment or colorant utilized in the lenses of the present invention should be bio-compatible with the eye, safe for use near or in the eye, and should not effect the functioning or integrity of the lens body.

The image component may comprise one or more traditional opaque pigments combined with one or more light diffractive colorants. Alternatively, the image component may comprise alternate layers of opaque pigments and light diffractive colorants, for example in the form of particles or flakes of a light diffracting material. More specifically, the image component may comprise one or more layers of light diffractive colorants disposed over a dark background layer that is located on a surface of the lens. The dark background layer may be a black layer of ink disposed on the surface of the lens. Or, the light diffractive colorants may be disposed over a colored background layer that has a color other than black.

This particular embodiment of the invention may be more clearly understood with reference to FIG. 4, which shows a portion of the lens 10 comprising the lens body 12 and the image component 24 disposed on the anterior surface thereof. As shown, the image component 24 comprises a light diffractive component in the form of flakes 30 of a multilayered interference film suspended in, and randomly distributed throughout, a polymeric medium 34.

Suitable interference films useful in the present invention, particularly multilayered color shifting flakes, are described in Bradley, Jr. et al. U.S. Pat. No. 6,243,204 B1, the disclosure of which is incorporated herein in its entirety by this specific reference.

The color shifting flakes 30 may be formed from a substantially symmetrical multilayer thin film coating structure. Such thin film coatings are typically made by methods well known in the art of forming thin coating structures, such as physical vapor deposition (PVD). As discussed in greater detail in the above noted Bradley, Jr. et al. patent, the coating structure is formed on a flexible web material and is removed therefrom as thin film flakes, which can be added to a liquid medium such as various pigment vehicles for use as a colorant with color shifting properties. As indicated hereinabove, the colorant is preferably exposed to a passivator to reduce the generation of undesirable by-products that may be associated with components of the colorant reacting with water present in the liquid medium. Generally, a collection of such thin film flakes added to a liquid medium produces a predetermined optical response through radiation incident on a surface of the solidified medium.

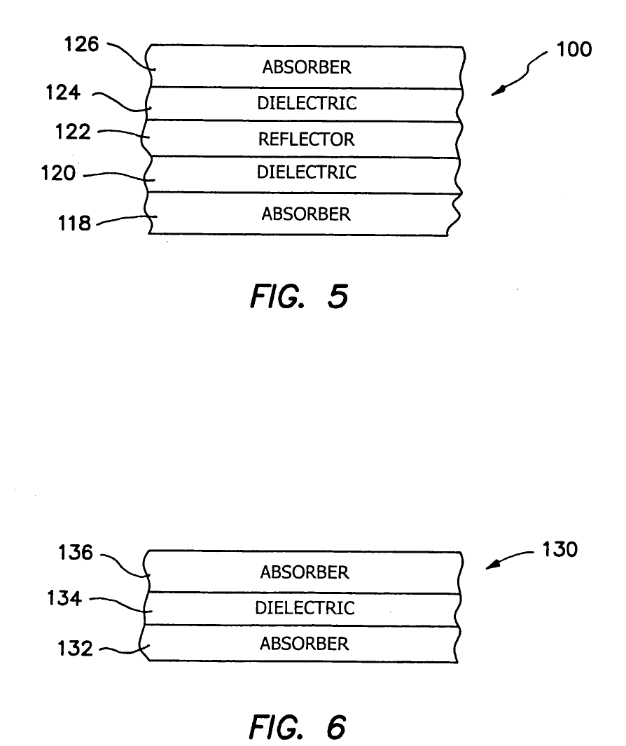

This may be more clearly understood with reference to FIG. 5 which is a schematic depiction of a suitable multilayer interference film 100 having color shifting characteristics. As described in Bradley Jr., et al, the interference film 100 is formed on a web (not shown) of a flexible material such as a polyester material (e.g., polyethylene terephthalate). A release layer (not shown) of a suitable type is formed on an upper surface of the web, allowing interference film 100 to be removed as thin flakes. The release layer may be an organic solvent soluble or water soluble coating such as acrylic resins, cellulosic propionates, (polyvinyl pyrrolidine) polyvinyl alcohol or acetate, and the like.

A first absorber layer 118 of interference film 100 is deposited on the release layer by a conventional deposition process such as PVD. The absorber layer 118 is formed to have a suitable thickness of about 50-150 Angstroms (Å), and preferably a thickness of about 70-90 Å. The absorber layer 118 can be composed of a semi-opaque material such as a grey metal, including metals such as chromium, nickel, titanium, vanadium, cobalt, and palladium, as well as other metals such as iron, tungsten, molybdenum, niobium, aluminum, and the like. Various combinations and alloys of the above metals may also be utilized, such as Inconel (Ni—Cr—Fe). Other absorber materials may also be employed in absorber layer 118 such as carbon, germanium, cermet, ferric oxide or other metal oxides, metals mixed in a dielectric matrix, and the like.

A first dielectric layer 120 is then formed on absorber layer 118 by a conventional deposition process. The dielectric layer 120 is formed to have an effective optical thickness for imparting color shifting properties to interference film 110. The optical thickness is a well known optical parameter defined as the product ηd, where η is the refractive index of the layer and d is the physical thickness of the layer. Typically, the optical thickness of a layer is expressed in terms of a quarter wave optical thickness (QWOT.) which is equal to 4 ηd/λ, where λ is the wavelength at which a QWOT condition occurs. The optical thickness of dielectric layer 20 can range from about 2 QWOT at a design wavelength of about 400 nm to about 9 QWOT at a design wavelength of about 700 nm, depending upon the color desired. Suitable materials for the dielectric layer include those having an index of refraction of greater than about 1.65, and preferably about 2 or greater.

Examples of suitable materials for the dielectric layer include zinc sulfide, zirconium oxide, tantalum oxide, silicon monoxide, cerium oxide, hafnium oxide, titanium oxide, praseodymium oxide, yttrium oxide, combinations thereof, and the like.

A reflector layer 122 is formed on dielectric layer 120 by a conventional deposition process. The reflector layer 122 is formed to have a suitable thickness of about 500-1000 Å, and preferably a thickness of about 700-900 Å. The reflector layer 122 is preferably composed of an opaque, highly reflective metal such as aluminum, silver, copper, gold, platinum, niobium, tin, combinations and alloys thereof, and the like, depending on the color effects desired. It should be appreciated that semi-opaque metals such as grey metals become opaque at approximately 350-400 Å. Thus, metals such as chromium, nickel, titanium, vanadium, cobalt, and palladium, could also be used at an appropriate thickness for reflector layer 122.

A second dielectric layer 124 is then formed on reflector layer 122 by a conventional deposition process. The second dielectric layer 124 is preferably formed of the same material and has the same thickness as first dielectric layer 120 described above. For instance, dielectric layer 124 can be formed of zinc sulfide or other suitable dielectric material having a refractive index of greater than about 1.65 at a suitable optical thickness as described above.

Lastly, a second absorber layer 126 is deposited on second dielectric layer 124 by a conventional deposition process. The second absorber layer 126 is preferably formed of the same material and has the same thickness as first absorber layer 118. For example, absorber layer 126 can be formed of a grey metal such as chromium or other absorber material at a suitable thickness as described above.

The formed interference film 100 shown in FIG. 5 is a five-layer design having a symmetrical multilayer structure on opposing sides of the reflector layer, which provides the maximum optical effects from flakes made from film 100.

Flakes can be formed which are non-symmetrical. For example, the flakes can omit the dielectric layer and the absorber layer from one side of the reflector layer, or different dielectric thicknesses on either side of the reflector layer may be utilized. When two sides have asymmetry with respect to the dielectric layer thickness, the flakes would have different colors on each side thereof and the resulting mix of flakes would show a new color which is the combination of the two colors. The resulting color would be based on additive color theory of the two colors coming from the two sides of the flakes. In a multiplicity of flakes, the resulting color would be the additive sum of the two colors resulting from the random distribution of flakes having different sides oriented toward the observer.

FIG. 6 depicts another embodiment of a multilayer interference film 130 useful in the present invention and having color shifting characteristics.

The film includes a first absorber layer 132 deposited on a web and release layer (not shown) by a conventional deposition process such as PVD and having a suitable thickness of about 50-150 Å, and preferably a thickness of about 70-90 Å. The absorber layer 132 can be composed of a semi-opaque material such as a grey metal, metal oxide, or other absorber material, such as those discussed above for film 100.

A dielectric layer 134 is formed on absorber layer 132 by a conventional deposition process. The dielectric layer 134 is formed to have an effective optical thickness for imparting a color shifting feature to interference film 130. For example, the optical thickness of dielectric layer 134 can range from about a 2 QUOT. at a design wavelength of about 400 nm to about a 9 QUOT. at a design wavelength of about 700 nm. Suitable materials for the dielectric layer include those having an index of refraction of greater than about 1.65, and preferably about 2 or greater. Examples of such materials for the dielectric layer include zinc sulfide, zirconium oxide, or other dielectric materials such as those discussed above for film 100.

A second absorber layer 136 is deposited on dielectric layer 134 by a conventional deposition process to complete the structure of interference film 130. The second absorber layer 136 is preferably formed of the same material and has the same thickness as first absorber layer 132. The formed interference film 130 thus has a symmetrical three-layer design. After the multilayer interference film of the type shown in FIG. 5 or 6 has been formed on a web, the interference film can be removed from the web by use of a solvent to form flakes or platelets which are sized to have a dimension on any surface thereof ranging from about 2 to about 200 microns. The flakes can be further reduced in size as desired. For example, the flakes can be subjected to an air grind to reduce their size to about 2-5 microns without destroying their desirable color characteristics.

The flakes are characterized by being comprised of a symmetrical multilayer thin film interference structure in which the layers lie in parallel planes such that the flakes have first and second parallel planar outer surfaces and an edge thickness perpendicular to the first and second parallel planar outer surfaces. The flakes are produced to have an aspect ratio of at least about 2:1, and preferably about 5-10:1 with a narrow particle size distribution. The aspect ratio of the flakes is ascertained by taking the ratio of the longest planar dimension of the first and second outer surfaces to the edge thickness dimension of the flakes.

In order to impart additional durability to the color shifting flakes, it is often desirable to anneal or heat treat the flakes at a temperature ranging from about 200-300° C., and preferably from about 250-275° C., for a time period ranging from about 10 minutes to about 24 hours, and preferably a time period of about 15-30 minutes. After the color shifting flakes have been sized, they can be blended with other flakes to achieve the color desired by adding flakes of different hues, chroma and brightness to achieve a desired result.

In accordance with the present invention, the color shifting flakes may be dispersed into a polymeric medium and in some instances, are mixed with a pigment vehicle conventionally used for tinting or coloring contact lenses. Additives of other types can be mixed with the pigment vehicle to achieve the final desired effects. These additives include lamellar pigments such as aluminum flakes, graphite, carbon aluminum flakes, mica flakes, and the like, as well as non-lamellar pigments such as aluminum powder, carbon black, and other organic and inorganic pigments such as titanium dioxide, and the like.

The color shifting flakes are sometimes combined with non-shifting high chroma platelets to produce unique color effects. In addition, the color shifting flakes can be combined with highly reflective platelets such as MgF₂/aluminum/MgF₂ platelets to produce additional color effects.

In addition, one or more phosphorescent pigments may be provided on the lens to permit the lens to glow when placed on a person's eye. These materials usually will absorb energy, such as light energy, and emit radiant energy over prolonged periods of time. The materials may be polymeric materials that are incorporated on or in the lens body. In certain embodiments, these materials are incorporated with the color shifting materials to provide unique visual appearances to the lenses.

In accordance with the present invention, by using an absorber/dielectric flake design such as shown in FIGS. 5 and 6, high chroma durable ink can be achieved in which variable color effects are subtly or dramatically noticeable to an observer of the lens 10. Thus, a lens 10 in accordance with the invention will change color depending upon variations in the viewing angle or the angle of the lens wearer's eye relative to the viewing eye. By way of example, colors which can be achieved utilizing the interference flakes according to the invention can have color shifts such as gold-to-green, green-to-magenta, blue-to-red, green-to-silver, magenta-to-silver, etc.

The lenses 10 of the invention can be produced with wide ranges of color shifting properties, including large shifts in chroma (degree of color purity) and also large shifts in hue (relative color) with a varying angle of view. Alternatively, the image component may be disposed between an anterior surface and a posterior surface of the lens body to define an annulus of a light diffracting material having an opening around an optic zone of the lens.

In one embodiment of the invention, the image component comprises a layer of light diffractive colorant located on the anterior surface of the lens and an optically clear or translucent polymeric layer disposed over the layer of light diffractive colorant. Additionally, another optically clear or translucent polymeric layer may be located on a surface of the lens, with the layer of light diffractive colorant located between the polymeric layers.

In yet another embodiment of the invention, the image component comprises one or more layers of colored pigment for example pigment particles, disposed on or in the lens body and structured and positioned to create a three-dimensional appearance of at least a portion of an eye. The pigment particles may comprise opaque, translucent or transparent particles.

For example, the at least one pigment layer may comprise a plurality of ink pixels, for example, dispensed from a printer, for example an ink-jet printer. To achieve certain visual effects, at least a minor portion of the ink pixels may be at least partially or completely bleached. The ink pixels may be printed on the lens in the form of a digital image, for example, in a pattern of an iris of an eye. Furthermore, in accordance with the invention, the image component may comprise several different layers of pigment particles, for example, wherein each layer has a different color and/or pattern of pigment, in order to achieve a desired visual effect.

The present invention also provides a method for making an ophthalmic lens, for example a contact lens having color shifting properties. Generally, a method for making a lens may comprise the steps of printing a digital image onto a releasable substrate and transferring the image printed on the substrate directly to a surface of an optically clear lens.

In one embodiment, the printing step comprises printing an iris pattern on a substrate, preferably a substantially flat, releasable substrate, using a laser printer or an ink-jet printer.

The printing step may more specifically comprise dispensing a light diffractive colorant with or without at least one colored ink onto a releasable substrate, for example a substantially flat, releasable substrate.

In one embodiment of the invention, the method further comprises the step of obtaining a digital image of an iris of an eye, and using that digital image for the printing step, for example printing a light diffracting material alone or in combination with one or more different colored inks, onto the substrate to form the pattern of an iris.

The transferring step may comprise transferring the printed image onto a resilient pad and transferring the image from the resilient pad onto the surface of the lens.

The transferring step may further comprise positioning the substrate with the image located thereon adjacent to the surface of the lens so that the image can be directly transferred from the releasable substrate to the lens body.

It has been found that this method of the invention has substantial advantages over conventional cliché or pad-printing techniques, for example by eliminating costly cliché alignment required to print multiple colors, eliminating the need for costly steel and plastic clichés, and reducing mess caused by conventional pad printing techniques. This method of the invention also provides higher resolution to the image component relative to a lens having an image component printed thereon using conventional cliché techniques. In addition, by using the method of the present invention, the eye practitioner can remotely order any desired shade of iris pattern via suitable form of digital or electronic communication for a quick customized iris design or digital iris cloning.

In another embodiment, a method for making an ophthalmic lens having a color-shifting property, such as a color-shifting contact lens, may utilize a spin cast molding technique. For example, a color shifting medium, such as a color shifting ink, described herein, may be printed on or in a spin-casting mold, such as a polyvinyl chloride (PVC) mold. A lens forming material, such as a HEMA monomer mixture, and the like, may be added to the mold. The mold may be spun and exposed to radiation to facilitate polymerization of the lens material. The resulting polymerized lens may then be removed from the mold. The resulting lens includes an image component with a color-shifting property.

In an additional embodiment, a second image forming material may be applied to a mold. For example, a mold may receive an amount of color-shifting ink, as described above. The application of the color-shifting ink may then be followed by the addition of a single color ink or ink-like material. The single color ink may have any desired color, such as blue, green, red, yellow, and the like. The ink or ink-like material that is added to the mold after the addition of the color-shifting material is effective as a background color to the color-shifting material when the lens is being worn.

### EXAMPLES

The following Table represents three different examples of contact lenses in accordance with the present invention. The Table shows relative percentages of each component used to create the image component that was printed on the lens body.

| | Example 1 | Example 2 | Example 3 |
|---|---|---|---|
| Component | (%) | (%) | (%) |
| pHEMA/GMA binder | 56 | 50 | 50 |
| Ethyl lactate | 16 | 18 | 16 |
| ChromaFlair ® Silver-green 060L | 8 | — | — |
| ChromaFlair ® Green purple 190L | — | 12 | — |
| SpectraFlair ® Silver 1400 | — | — | 14 |
| TETA* activation solvent | 20 | 20 | 20 |
| solution | | | |

*10% TETA refers to triethylenetetramine in ethyllactate.

SpectraFlair® and/or ChromaFlair® pigment (manufactured by Flex Products, Inc.) was dispersed into polyHEMA/GMA binder using a dual asymmetric centrifuge technique such that the pigment particle size was not broken down to an extent that the pigment would lose its diffractive properties.

The rest of the components shown in above table were added and hand mixed until a homogeneous mixture was achieved. Using a pad printing technique, iris patterns were printed and the prints were thermally cured for complete polymerization. A lens forming material, HEMA monomer mixture was added to the mold. The molds were thermally polymerized for one hour. The resulting polymerized lens was then be removed from the mold. The resulting lens was hydrated and extracted as per conventional procedures well known to by persons of ordinary skill in the art and in the contact lens industry.

Colors were subtle but with dramatic color shifting rainbow effects. The color varied and changed as viewing angle or angle of incident light changed. Accordingly, a contact lens, in accordance with a specific embodiment of the invention, comprises an image component effective in producing a rainbow colored spectral appearance.

In another example, a dispersion of the colorant is prepared before being mixed with the polyHEMA/GMA binder. A dispersion of SpectraFlair is made by mixing 20 grams of SpectraFlair pigment, 35 grams of Dowanol® PNB (Dow Chemical Company, Midland, Mich.), and 3 grams of Additol XL 250. After these components are mixed, 0.5 grams of AMP95 (2-amino, 2-methyl, 1-propoanol) is added, and the mixture is mixed for about 30 minutes. The resulting dispersion is then added, as indicated above, with routine adjustments for pH and/or viscosity, as desired. Similarly, a dispersion of ChromaFlair is made by mixing 20 grams of ChromaFlair Pigment and 20 grams of Hexyl Cellosolve until blended. Subsequently, 1 gram of Vircopet 40 is added and the slurry is mixed for 30 minutes. Subsequently, 1 gram of AMP95 is added, and the slurry is mixed for another 15 minutes. Deionized water (58 grams) is then added to the slurry and is mixed for another 15 minutes. The final dispersion is dried and then added, as indicated above, with routine adjustments for pH and/or viscosity, as desired.

In another example, a spin-casting mold was printed using the above-described color-shifting ink. A HEMA monomer mixture was dispensed into the mold. The mold was subsequently exposed to ultraviolet radiation for about ten minutes while the mold was being spun. After polymerization of the monomer mixture, a cured dry lens was removed from mold and hydrated/extracted per conventional procedures known to persons of ordinary skill in the art, including contact lens manufacturers. The resulting lens had a color-shifting property, as disclosed herein.

In an additional example, ChromaFlair pigment-containing ink was printed on or in a spin-casting mold, as described above. Subsequently, a blue or green ink was printed on or in the mold. The blue ink was produced using phthalocyanine blue pigment, and the green ink was produced using phthalocyanine green pigment. A HEMA monomer mixture was added to the mold. The mold was spun and the lens material was polymerized. The resulting lens thus contained a color-shifting image component with a colored background.

Other examples of the present invention comprise a lens body and an image component disposed on or in said lens body and including a mixture of SpectraFlair® or ChromaFlair® and a pigment conventionally used for tinting contact lenses. The image component may include various mixtures of SpectraFlair® or ChromaFlair® with one or more pigments, for example organic or inorganic pigments. Pigments useful with the present invention include phthalocyanine blue, phthalocyanine green, titanium dioxide, iron oxides, and colorants such as Carbazol violet colorant. To achieve a desired image effect, one or more of these pigments is mixed in various proportions with SpectraFlair® and/or ChromaFlair® to achieve a desired color shifting effect of the lens.

The entire lens or a portion thereof may be coated using the mixture to produce a color shifting diffractive contact lens in accordance with the invention. A clear contact lens may be printed to create a “rainbow” lens as described elsewhere herein.

A number of patents have been referred to herein, each of these patents is hereby incorporated by reference in its entirety.

While this invention has been described with respect to various specific examples and embodiments, it is to be understood that the invention is not limited thereto and that it can be variously practiced within the scope of the following claims.

What is claimed is:

1. A contact lens comprising:
a lens body having an optical region, an anterior surface and a posterior surface; and
an image component disposed on or within said lens body, said component being effective in producing a color shifting appearance.

2. The lens of claim 1 wherein the image component comprises a light diffractive component.

3. The lens of claim 1 wherein the image component comprises a multilayered interference film.

4. The lens of claim 1 wherein the image component comprises particles of a multilayered interference film.

5. The lens of claim 4 wherein the image component comprises particles having a size less than about one hundred micrometers.

6. The lens of claim 3 wherein the image component further comprises a medium and the particles are distributed throughout the medium.

7. The lens of claim 6 wherein the medium comprises a polymeric material.

8. The lens of claim 7 wherein the polymeric material comprises a co-polymer of HEMA (2-hydoxyethyl methacrylate) and GMA (glyceryl monomethacrylate).

9. The lens of claim 1 wherein the image component comprises a multilayered interference film that is substantially absent of any intrinsic color.

10. The lens of claim 1 wherein the image component comprises particles of a plurality of multilayered interference films, each of the films being effective in exhibiting a different light interference property.

11. The lens of claim 1 wherein the image component comprises particles of a multilayered interference film and particles of a reflective film.

12. The lens of claim 1 wherein the image component is provided as a layer located on the anterior surface of the lens body.

13. The lens of claim 1 wherein the image component is integrated into at least a portion of the lens body.

14. The lens of claim 1 wherein the image component is provided in a medium that is expelled from an ink jet printer.

15. The lens of claim 1 wherein the image component is effective in producing a rainbow colored spectral appearance.

16. The lens of claim 1, wherein the lens further comprises a phosphorescent pigment material.

17. A contact lens comprising:
a lens body having an optical region, an anterior surface and a posterior surface; and
an image component provided on or in the lens body to create a colored image, and structured to interfere with incident light to cause a color of the image to change when the lens is viewed from different angles.

18. The lens of claim 17, wherein the image component is provided in an annulus on a surface of the lens.

19. The lens of claim 17, wherein the image component is disposed between the anterior surface and the posterior surface of the lens to define an annulus having an opening around the optic zone of the lens.

20. The lens of claim 17, wherein the image component comprises a light diffracting component.

21. The lens of claim 17 wherein the image component comprises particles of a multilayered interference film.

22. The lens of claim 21 wherein the image component comprises particles having a size of less than about one hundred micrometers.

23. The lens of claim 17, wherein the image component comprises a layer of light-diffractive colorant located on the anterior surface of the lens and an optically clear polymeric layer disposed over the layer of light-diffractive colorant.

24. The lens of claim 17, wherein the image component is structured to create a three-dimensional appearance of at least a portion of an eye.

25. The lens of claim 17, wherein the image component further comprises at least one non-diffractive colorant.

26. The lens of claim 25, wherein the non-diffractive colorant comprises a colored ink.

27. The lens of claim 17, wherein the image component comprises a plurality of ink pixels printed on the lens body.

28. The lens of claim 27, wherein a portion of the ink pixels are bleached.

29. The lens of claim 17, wherein the image component is provided in a pattern of an iris of an eye.

30. A method for making an ophthalmic lens, comprising:
printing a digital image on a substrate; and
transferring the image printed on the substrate to a surface of an optically clear ophthalmic lens.

31. The method of claim 30, wherein the printing step comprises printing an image on a substantially flat substrate.

32. The method of claim 30, wherein the image is printed with an ink jet printer.

33. The method of claim 30, wherein the transferring step comprises transferring the printed image onto a resilient pad and transferring the image on the resilient pad to the surface of the lens.

34. The method of claim 30, wherein the image comprises a light diffractive component effective in producing a color shifting appearance when the lens is placed on an eye.

35. The method of claim 30 further comprising adding a phosphorescent material to the lens to provide a phosphorescent signal when the lens is worn on an eye.
